(19) United States
(12) Patent Application Publication
(10) Pub. No.: US 2009/0272087 A1
(43) Pub. Date: Nov. 5, 2009

(54) Yard Debris Catcher

(76) Inventor: Makoto Shirasawa, Simi Valley, CA (US)

Correspondence Address: Makoto Shirasawa, 590 Bristol Ave, Simi Valley, CA, 93065, US

(21) Appl. No.: 12/114,797

(22) Filed: May 4, 2008

(51) Int. Cl. A01D 11/00

(52) U.S. Cl. 56/1

(57) ABSTRACT

This Yard debris catcher on wheels is for anyone cleaning up Yard clippings, leaves, small branches, or collecting any other type of small debris. The body of the catcher is perforated so if cleanup includes the use of a leaf blower, debris is left in the catcher, yet air is able to pass through. The leaf blower attachment is designed to help reduce the air current coming from a leaf blower so that debris can be gathered into the catcher in a controlled manner.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

The field of endeavor to which the invention pertains is in lawn or landscaping maintenance.

### BRIEF SUMMARY OF THE INVENTION

Invention is a catcher made of lightweight perforated aluminum or other metal/alloy on wheels with a wooden, plastic, or metal handle attached. Catcher body has movable flaps at opening to adjust width of catcher body mouth. Yard Debris Catcher (YDC) includes Leaf Blower Attachment (LBA).

The objective and advantage of the invention is that is reduces additional time and effort spent on going back and collecting yard debris after trimming or cutting grass, shrubs, plants, or trees.

### BRIEF DESCRIPTION OF THE SEVERAL VIEWS OF THE DRAWINGS

FIG. 1—Yard debris catcher (YDC) ¾ rear view showing body, wheels, and handle

FIG. 2—YDC Partial top view showing left side flap

FIG. 3—YDC Top view with measurements
FIG. 4—YDC Left side view with measurements

FIG. 5—YDC Rear view with measurements

FIG. 6—Leaf blower attachment (LBA) ¾ side view

FIG. 7—LBA Top view

FIG. 8—LBA connection detail with measurements

FIG. 9—LBA Top view with measurements

FIG. 10—LBA Left side view with measurements

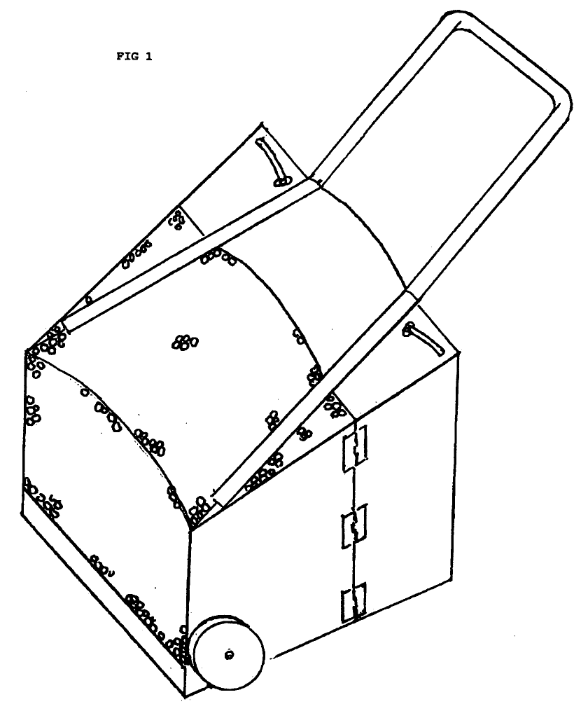

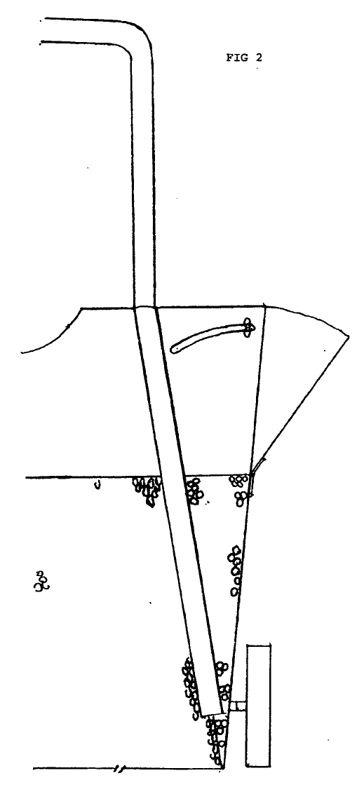

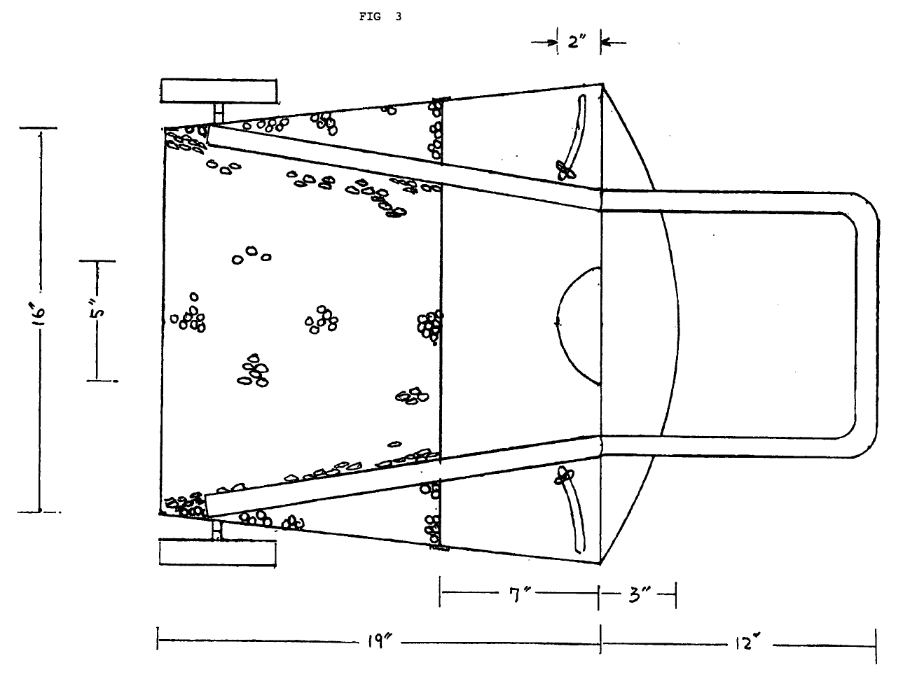

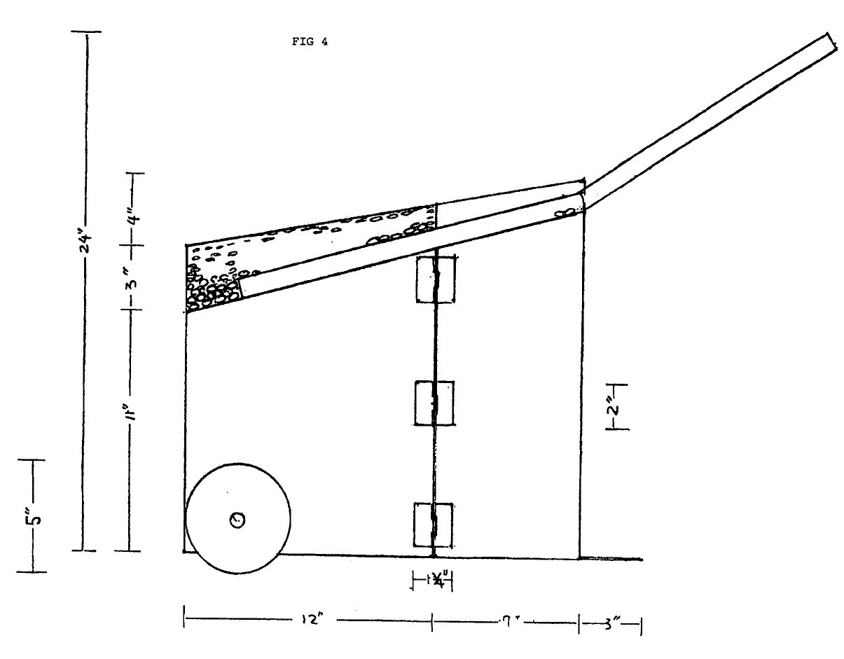

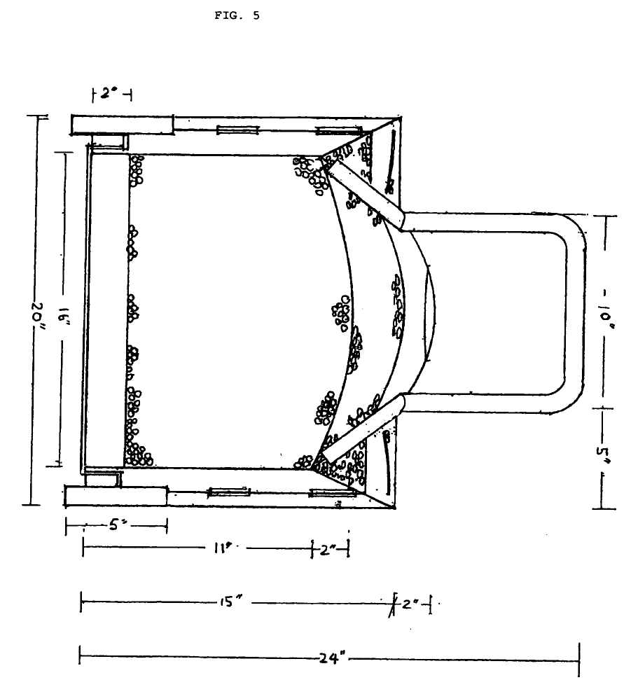

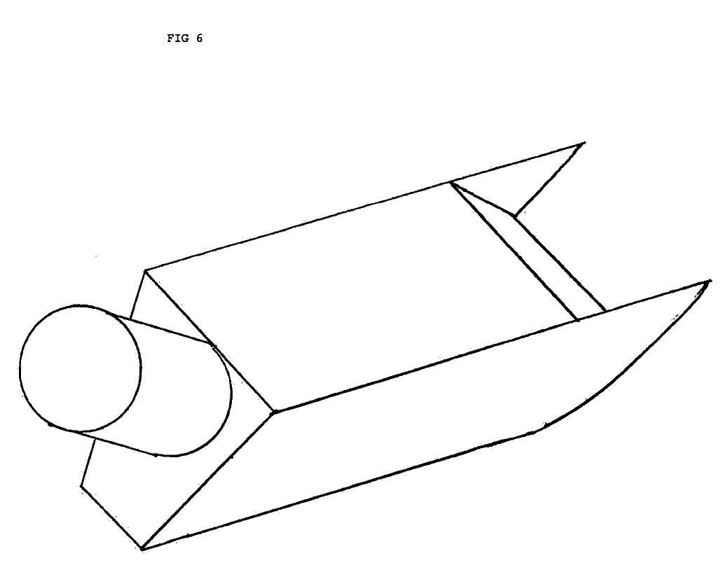

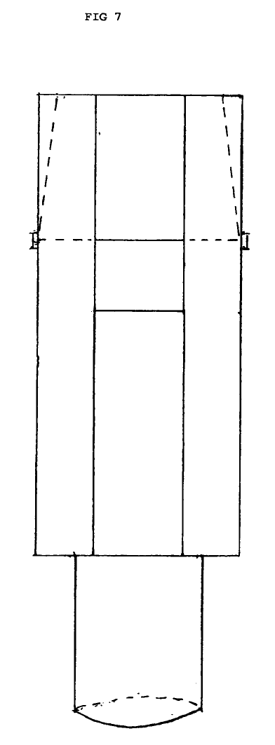

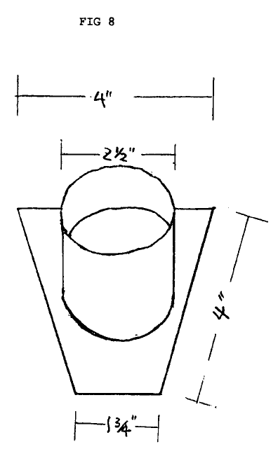

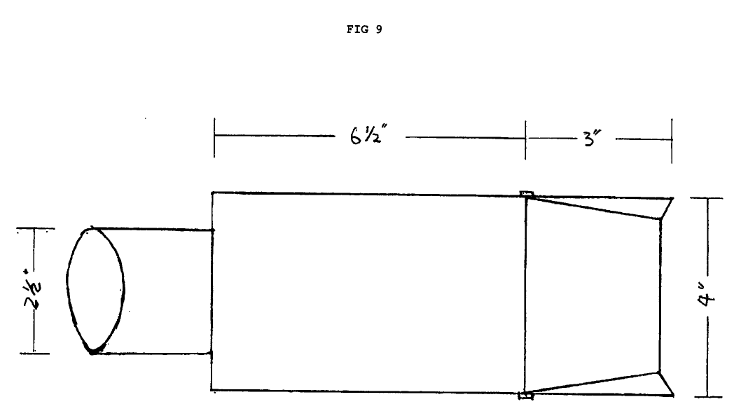

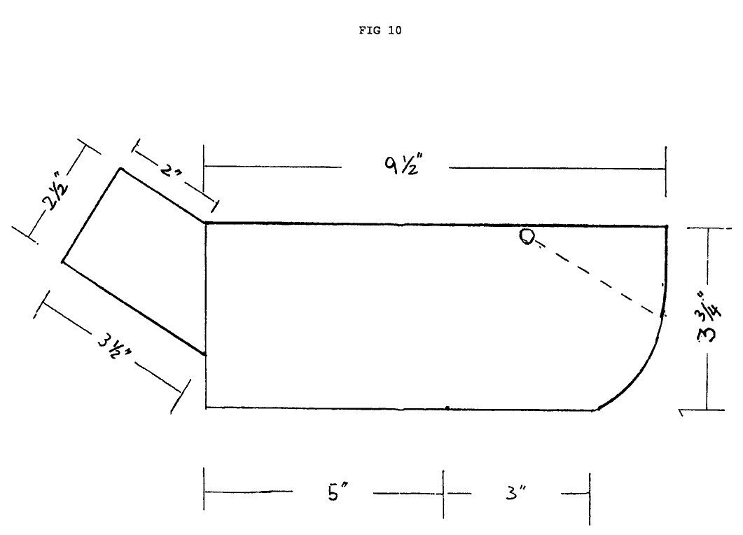

### DETAILED DESCRIPTION OF THE INVENTION

Invention is a catcher made of lightweight perforated aluminum or other metal/alloy on wheels with a wooden, plastic, or metal handle attached. Catcher body has movable flaps attached with hinges at opening to adjust width of catcher body mouth. Yard Debris Catcher (YDC) includes Leaf Blower Attachment (LBA), made of lightweight yet sturdy plastic material. The LBA is designed to help reduce the air current coming from a leaf blower so that debris can be gathered into the catcher in a controlled manner.

1. The invention claimed in this specification is the yard debris catcher (LDC). Invention is a catcher made of lightweight perforated aluminum or other metal/alloy on wheels with a wooden, plastic, or metal handle. Catcher body has movable flaps attached with hinges at opening to adjust width of catcher body mouth. Yard debris catcher (LDC) includes leaf blower attachment (LBA), made of lightweight yet sturdy plastic material.
